(19) United States
(12) Patent Application Publication
(10) Pub. No.: US 2022/0195183 A1
(43) Pub. Date: Jun. 23, 2022

(54) POLYURETHANE THERMOPLASTIC ELASTOMER BASED ON HEXAMETHYLENE DIISOCYANATE

(71) Applicants: SOPREMA, STRASBOURG (FR); EIFFAGE INFRASTRUCTURES, VELIZY VILLACOUBLAY (FR); INSTITUT NATIONAL DES SCIENCES APPLIQUEES DE LYON, VILLEURBANNE (FR); UNIVERSITE CLAUDE BERNARD LYON 1, VILLEURBANNE (FR); CENTRE NATIONAL DE LA RECHERCHE SCIENTIFIQUE - CNRS -, Paris (FR); UNIVERSITE JEAN MONNET SAINT ETIENNE, SAINT ETIENNE (FR)

(72) Inventors: Rémi PERRIN, BOERSCH (FR); Pierre Etienne BINDSCHEDLER, STRASBOURG (FR); Christine ROBACH, OSTHOFFEN (FR); Frédéric LOUP, VILLEURBANNE (FR); François OLARD, LYON (FR); Raïssa GALLU, VILLEURBANNE (FR); Florent DALMAS, LYON (FR); Jean-François GERARD, BRON (FR); Françoise MECHIN, LYON (FR)

(21) Appl. No.: 17/603,875

(22) PCT Filed: Apr. 22, 2020
(86) PCT No.: PCT/FR2020/050686

§ 371 Date: Oct. 14, 2021

(30) Foreign Application Priority Data
Apr. 25, 2019 (FR) 19 04357

(51) Int. Cl. C08L 75/06; C08G 18/10; C08G 18/32; C08G 18/42; C08G 18/73

(52) U.S. Cl. CPC C08L 75/06; C08G 18/10; C08G 18/3206; C08L 95/00; C08G 18/73; C08G 2350/00; C08G 18/4238

(57) ABSTRACT

The present invention relates to a polyurethane thermoplastic elastomer, to a composition comprising said polyurethane and a binder, for example bitumen and/or a biobased binder, and also to the use of the composition for the preparation of a waterproofing membrane, a soundproofing membrane, a liquid sealing system, a bituminous mix surfacing, a mastic asphalt surfacing, a primer, a varnish, a mastic, an adhesive or a binder emulsion

### TECHNICAL FIELD

The present disclosure relates to a thermoplastic polyurethane elastomer, to a composition comprising said polyurethane and a binder, for example asphalt and/or a biobased binder, and also to the use of the composition for the preparation of a waterproofing membrane, of a soundproofing membrane, of a liquid waterproofing system, of a roadway pavement, of a primer, of a varnish, of a mastic, of an adhesive or of a binder emulsion.

### PRIOR ART

Bituminous mixes and membranes based on asphalt modified by polymers of the SBS (Styrene/Butadiene/Styrene) or APP (=PPA: Atactic Polypropylene) or PE (Polyethylene) type, which have been widely developed since the 1970s in the sector of road construction, of the waterproofing of flat roofs or of soundproofing, have been known for many years.

Modification of the straight-run asphalts resulting from the refining of crude oil is a necessity. This is because conventional asphalts exhibit a thermal susceptibility which makes them brittle for temperatures typically of less than −5° C. (cold cracking) and causes them to creep for temperatures of greater than ambient (creep/rutting).

In point of fact, these operating temperatures are too limiting for use on roofs or in roadway pavements, for which the service temperature range, depending on the climate, can vary between −40° C. and up to 110° C.

It is thus necessary to modify the asphalt. Conventional techniques consist in adding, to the asphalt, thermoplastic polymers of the type of block elastomers [SBS or SEBS (styrene/ethylene/butadiene/styrene)] or plastomers [polyolefin of the PPA, EVA (ethylene/vinyl acetate), IPP (isotactic polypropylene), APAO (amorphous poly-α-olefin) or PE (polyethylene) type].

Thus, by a modification using SBS elastomers, it is possible to obtain a bituminous composition having a softening point ranging up to 125° C. and a flexibility at low temperatures, that is to say which can reach −30° C. approximately. The operating range of an asphalt modified with plastomer polymers is generally between −15° C. and 150° C.

However, the membranes produced based on asphalts modified with the abovementioned polymers have their limits:
SBS polymers are UV-sensitive and, for this reason, the final layer (surface layer) requires additional specific protection against attack by UV radiation;
plastomer polymers exhibit mediocre flexibilities at low temperatures and the membrane seals produced with compositions containing these polymers do not give a satisfactory resistance to heat.

Roadway pavements based on asphalts modified with polymers also have their limits:
as for the membranes, SBS polymers are sensitive to UV radiation, which can cause aging of the surface layers (cracking, loss of cohesion, and the like);
plastomer polymers cause brittleness at low temperatures, which is also expressed by the appearance of cracks.

The traffic moving over these pavements also generates stresses which are additional to the abovementioned thermal stresses and are consequently the cause of additional degradation (creep, rutting, fatigue).

In the context of the membranes, the additional specific protection against attack by UV radiation, when it is incorporated in the prefabricated membrane, is currently produced either with metal strips (aluminum, copper or stainless steel) or by flakes or granules of slates or mica sprinkled on the surface during the manufacturing process. These “self-protection” protections lead to an excess weight ranging up to 1.5 kg/m², representing up to 30% of the weight of the membrane and increasing the cost price of the final membrane.

Besides the UV radiation, these abovementioned known products age quickly compared to the lifetime of the structures to which they are applied and degrade by oxidation, not allowing viable waterproofing over a long period of time or durability of the roadway layers. The periodicity of repairs to the waterproofing is of the order of 15-20 years and of 10-15 years for a wearing course made of bituminous mix.

In recent years, bituminous surfacings modified with polyurethanes have been developed. These products are applied above all in road pavements and the waterproofing of civil engineering works and buildings. The known products of this type are either:
cold applicable: the product is in single- or two-component liquid form, and achieves its characteristics after crosslinking, which takes place in the open air,
hot applicable: polymerization-crosslinking takes place in the hot asphalt just before its application at site.

For example, the French patent application No. 2 064 750 on behalf of Naphtachimie describes a thermoplastic bituminous composition containing less than 10% by weight of thermosetting polyurethane. The polyols used to synthesize the polyurethane have functionalities of greater than 2, which can range up to 8, and the NCO/OH ratio is between 1 and 2, preferably in the vicinity of 1.1. This bituminous composition exhibits thermoplastic properties due to the presence of polyurethane and can be applied to a fibrous support to produce a prefabricated membrane. However, the low percentage of polyurethane introduced does not make it possible to obtain sufficiently elastic and resistant membranes.

Furthermore, there is known, via the European patent application No. 1 013 716 on behalf of Soprema, a single-component liquid composition based on asphalt and on polyurethane prepolymer which polymerizes directly on the support to be waterproofed during its cold application at site. Thus, this bituminous composition is not thermoplastic and is not intended for the preparation of factory-prefabricated membranes.

There is known, via the patent application WO 97/03253 on behalf of Interface Inc., a sheet material intended to form a barrier against moisture and comprising a layer of an asphalt/polyurethane mixture protected by a polymer film and covered with a detachable film. The polyurethane used in the bituminous mixture is prepared with a polybutadiene polyol having a functionality between 2.2 and 2.6. Thus, the resulting polyurethane is thermosetting and sensitive, by its chemical nature, to degradation by UV radiation, hence the need to protect the bituminous layer with a polymer film. The material of this patent application is not thermoplastic and it is applied cold to the surface to be waterproofed and is held in place by the tackiness of the bituminous composition, possibly improved by the addition of a specific tackifier.

Soprema has described, in the French patent application No. 2 844 283, a prefabricated waterproofing membrane based on asphalt modified with thermoplastic polyurethane exhibiting the following formulation, the percentages being percentages by weight with respect to the total weight of the composition:
40% to 90% of asphalt,
10% to 50% of thermoplastic polyurethane obtained by reaction between a polyester polyol, diphenylmethylene diisocyanate (MDI) and 1,4-butanediol,
0% to 10% of aromatic oil,
0% to 50% of fillers, and
0% to 0.5% of catalyst.
   However, the bituminous composition obtained in this patent application exhibits limited mechanical properties and is sensitive to degradation at high temperature.

### Technical Problem

After numerous research studies, the applicant company has found that it is possible to obtain a thermoplastic polyurethane (TPU) elastomer with improved properties by using a specific diisocyanate, 1,6-diisocyanatohexane or hexamethylene diisocyanate. The TPU of the present invention exhibits high compatibility with binders of the type of asphalts and/or biobased binders. Thus, the composition obtained by mixing the TPU of the invention with a binder exhibits a specific crystalline structure which confers, on the composition of the invention, a rubbery flow at a lower temperature compared with the compositions of the prior art. Another advantage of the TPU of the present invention is that it exhibits a higher modulus G′ compared with the TPUs of the prior art. Thus, for an equal amount of TPU, the TPU of the invention makes it possible to obtain a surfacing exhibiting improved mechanical properties compared with those of a surfacing comprising a TPU of the prior art. Alternatively, with the TPU of the invention, it is possible to reduce the amounts of TPU used while retaining the mechanical properties of the surfacing obtained, which advantageously makes it possible to reduce the production costs.

### SUMMARY OF THE INVENTION

Thus, a subject matter of the invention is a thermoplastic polyurethane elastomer obtained by reaction between:
a polyol comprising a linear or branched C₁₂-C₆₀, preferably C₂₄-C₅₀, more preferentially C₃₀-C₄₀, chain, said polyol having a functionality of between 1.75 and 2.2, preferably between 1.85 and 2.1, more preferentially between 1.95 and 2.05, and a number-average molar mass of between 500 and 6000 g/mol, preferably between 900 and 5000 g/mol, more preferentially between 1500 and 3500 g/mol;
hexamethylene diisocyanate; and
a chain-extending diol chosen from 1,4-butanediol, 1,6-hexanediol, 1,4-cyclohexanedimethanol and their mixtures;
   with an NCO/OH ratio of between 0.95 and 1.02, preferably between 0.97 and 1.1, more preferentially between 0.98 and 1.

Another subject matter of the invention is a composition comprising a binder and the thermoplastic polyurethane elastomer according to the present invention, the composition comprising from 3% to 30%, preferably from 5% to 22%, by weight of thermoplastic polyurethane elastomer, with respect to the total weight of the binder and of the thermoplastic polyurethane elastomer.

Another subject matter of the invention is the use of the composition according to the invention for the preparation of a waterproofing membrane, of a soundproofing membrane, of a liquid waterproofing system, of a roadway pavement, of a primer, of a varnish, of a mastic, of an adhesive or of a binder emulsion.

### BRIEF DESCRIPTION OF THE DRAWINGS

Other characteristics, details and advantages will become apparent on reading the detailed description below, and on analyzing the appended figures, in which:

FIG. 1 shows the curve of the modulus G′ as a function of the temperature measured by DMA for the TPUs 1, 2 and 7 obtained in example 1.

FIG. 2 shows the curve of the modulus G′ as a function of the temperature measured by DMA for the TPUs 4, 5 and 8 obtained in example 1.

FIG. 3 shows the curve of the modulus G′ as a function of the temperature measured by DMA for the compositions 1, 2 and 3 obtained in example 2.

FIG. 4 shows the curve of the modulus G′ as a function of the temperature measured by DMA for the compositions 4, 5 and 6 obtained in example 2.

### DETAILED DESCRIPTION

### Thermoplastic Polyurethane Elastomer

The thermoplastic polyurethane elastomer according to the invention is obtained by reaction between a polyol, hexamethylene diisocyanate and a chain-extending diol.

Within the meaning of the present invention, the term “thermoplastic” is understood to mean a material which softens under the action of heat and which hardens on cooling reversibly without loss of properties.

Within the meaning of the present invention, the term “elastomer” is understood to mean a material which is capable of undergoing a strong elastic deformation, that is to say which is capable of returning to its initial shape when the stresses to which it is subjected are removed.

The thermoplastic polyurethane elastomer of the present invention can in particular be obtained by polymerization of three compounds: (i) a polyol comprising a linear or branched C₁₂-C₆₀, preferably C₂₄-C₅₀, more preferentially C₃₀-C₄₀, chain, said polyol having a functionality of between 1.75 and 2.2, preferably between 1.85 and 2.1, more preferentially between 1.95 and 2.05, and a number-average molar mass (Mₙ) of between 500 and 6000 g/mol, preferably between 900 and 5000 g/mol, more preferentially between 1500 and 3500 g/mol;

(ii) hexamethylene diisocyanate; and
(iii) a chain-extending diol chosen from 1,4-butanediol, 1,6-hexanediol, 1,4-cyclohexanedimethanol and their mixtures;
in specific proportions.

Thus, the NCO/OH ratio of the three compounds participating in the synthesis of the thermoplastic polyurethane elastomer is between 0.95 and 1.1, preferably between 0.97 and 1.02, more preferentially between 0.98 and 1. This is because, if the NCO/OH ratio is greater than 1.1, a polyurethane is obtained having free reactive sites which can cause side reactions and thus adversely affect its compatibility with the binder and thus the obtaining of suitable performance qualities. If the NCO/OH ratio is less than 0.95, a polyurethane is obtained exhibiting a deficit of rigid segments and an excessively low molar mass and thus an insufficient level of performance qualities.

Within the meaning of the present invention, the term “functionality of the polyol” is understood to mean the total number of reactive hydroxyl functional groups per mole of polyol.

The polyol has a hydroxyl number (N_{OH}) which is directly related to the functionality and the number-average molar mass (Mₙ) of said polyol and can be calculated with the following formula NO_{H}=(functionality of the polyol×56 109.37)/Mₙ polyol. The hydroxyl number corresponds to the number of mg of KOH necessary to neutralize the acid or the anhydride which combines by esterification with one gram of polyol.

Thus, according to one embodiment, the polyol has a hydroxyl number of between 18 mg KOH/g and 224 mg KOH/g, preferentially between 32 mg KOH/g and 75 mg KOH/g.
The hydroxyl number can be determined by back titration using potassium hydroxide.

According to the invention, the number-average molar mass (Mₙ) of the polyol can be evaluated by different methods, such as size exclusion chromatography or nuclear magnetic resonance.

Thus, once the hydroxyl number and the number-average molar mass of the polyol have been determined, it is possible to determine the value of the functionality of the polyol.

Or, conversely, once the functionality and the value of the hydroxyl number have been determined, it is possible to determine the number-average molar mass.

Within the meaning of the present invention, the term “NCO/OH ratio” is understood to mean the stoichiometric ratio of the number of NCO functional groups of the diisocyanate to the number of OH functional groups of the polyol and of the chain-extending diol. The NCO/OH ratio is calculated with the following formula:

[Math 1]

$$NCO / OH Ratio = \frac{{w}_{d i i s o} / E {W}_{diiso}}{( {w}_{p o l y o l} / E {W}_{polyol} ) + ( {w}_{diol} / E {W}_{d i o l} )}$$

where:

w_{diiso} is the weight of the hexamethylene diisocyanate;
w_{polyol} is the weight of the polyol;
w_{diol} is the weight of the chain-extending diol;
EW_{diiso} is the equivalent weight of hexamethylene diisocyanate and corresponds to the ratio of the molar mass of hexamethylene diisocyanate to the functionality of hexamethylene diisocyanate;
EW_{polyol} is the equivalent weight of the polyol and corresponds to the ratio of the number-average molar mass of the polyol to the functionality of the polyol;
EW_{diol} is the equivalent weight of the chain-extending diol and corresponds to the ratio of the molar mass of the chain-extending diol to the functionality of the chain-extending diol.

Within the meaning of the present invention, the term “functionality of hexamethylene diisocyanate” is understood to mean the total number of reactive isocyanate functional groups per mole of hexamethylene diisocyanate, namely 2.

Within the meaning of the present invention, the term “functionality of the chain-extending diol” is understood to mean the total number of reactive hydroxyl functional groups per mole of chain-extending diol, namely 2.

The polyol participating in the synthesis of the thermoplastic polyurethane elastomer of the present invention exhibits a functionality of between 1.75 and 2.2, preferably between 1.85 and 2.1, more preferentially between 1.95 and 2.05, and a number-average molecular weight (Mₙ) of between 500 and 6000 g/mol, preferably between 900 and 5000 g/mol, more preferentially between 1500 and 3500 g/mol.

According to a preferred embodiment, the polyol exhibits a mean functionality of 2.

The polyol comprises a linear or branched C₁₂-C₆₀, preferably C₂₄-C₅₀, more preferentially C₃₀-C₄₀, chain.

Within the meaning of the present invention, the term “linear or branched C₁₂-C₆₀ chain” is understood to mean a saturated or unsaturated, linear or branched, divalent hydrocarbylene radical comprising from 12 to 60 carbon atoms, it being possible for said radical to comprise one or more aliphatic and/or aromatic rings each having 6 carbon atoms. The linear or branched C₁₂-C₆₀ chain can be interrupted by one or more ether (—O—) functional groups. According to a particularly preferred embodiment, said hydrocarbon chain is not substituted by one or more halogenated, nitrogenous or hydroxylated groups.

Said polyol can in particular be chosen from a polyether polyol, a polyester polyol, a polycarbonate polyol, a polyolefin polyol, a polyol based on vegetable oil and their mixtures. Preferably, the polyol is a polyester polyol or a mixture of polyester polyols.

Polyester polyols are obtained by reaction between a dicarboxylic acid and a diol or by reaction between a cyclic ester and a diol. Examples of dicarboxylic acids which can be used are succinic acid, glutamic acid, octanedioic acid, sebacic acid, maleic acid, fumaric acid, phthalic acid, isophthalic acid and terephthalic acid. The dicarboxylic acid is advantageously a fatty dicarboxylic acid, that is to say a saturated or unsaturated aliphatic dicarboxylic acid comprising from 12 to 60 carbon atoms between the carboxylic acid functional groups which can, for example, be synthesized by dimerization of unsaturated aliphatic monocarboxylic acids or of unsaturated aliphatic esters having between 8 and 22 carbon atoms, such as linoleic acid and linolenic acid. An example of a cyclic ester which can be used is ε-caprolactone. Examples of diols which can be used are ethanediol, diethylene glycol, 1,2-propanediol, 1,3-propanediol, dipropylene glycol, 1,4-butanediol, 1,5-pentanediol, 1,6-hexanediol, 1,10-decanediol, glycerol, trimethylolpropane, tripropylene glycol, tetraethylene glycol, tetrapropylene glycol, tetramethylene glycol and 1,4-cyclohexanedimethanol. The diol can be a fatty diol, that is to say a saturated or unsaturated aliphatic diol comprising from 12 to 60 carbon atoms between the hydroxyl functional groups which can, for example, be synthesized by reduction of a fatty dicarboxylic acid described above.

According to a specific embodiment, the polyol is a polyester polyol formed by reaction between:
a linear or branched dicarboxylic acid comprising from 12 to 60, preferably from 24 to 50, more preferentially from 30 to 40, carbon atoms between the carboxylic acid (—COOH) functional groups; and
a diol comprising from 2 to 12, preferably from 3 to 10, more preferentially from 4 to 6, carbon atoms between the hydroxyl (—OH) functional groups.

Alternatively, the polyol can be a polyester polyol formed by reaction between:
a linear or branched diol comprising from 12 to 60, preferably from 24 to 50, more preferentially from 30 to 40, carbon atoms between the hydroxyl (—OH) functional groups; and
a dicarboxylic acid comprising from 2 to 12, preferably from 3 to 10, more preferentially from 4 to 6, carbon atoms between the carboxylic acid (—COOH) functional groups.

According to a particularly preferred embodiment, the polyol corresponds to the following formula:

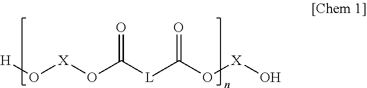

in which:

X is a saturated linear divalent hydrocarbylene radical comprising from 2 to 12, preferably from 3 to 10, more preferentially from 4 to 6, carbon atoms;
L is a saturated or unsaturated, linear or branched, divalent hydrocarbylene radical comprising from 12 to 60, preferably from 24 to 50, more preferentially from 30 to 40, carbon atoms, it being possible for said radical to comprise one or more aliphatic and/or aromatic rings each having 6 carbon atoms; more preferentially, L is a branched divalent hydrocarbylene radical comprising from 30 to 40 carbon atoms, said radical comprising an aliphatic ring having 6 carbon atoms;
n ranges from 1.5 to 10, preferably from 2 to 8, more preferentially from 2.5 to 6.

The diisocyanate participating in the synthesis of the thermoplastic polyurethane elastomer of the present invention is hexamethylene diisocyanate (HDI), which is an aliphatic diisocyanate having two NCO functional groups.

The chain-extending diol participating in the synthesis of the thermoplastic polyurethane elastomer of the present invention is chosen from the group consisting of 1,4-butanediol, 1,6-hexanediol, 1,4-cyclohexanedimethanol and their mixtures.

According to a specific embodiment, the chain-extending diol is 1,4-butanediol.

According to a specific embodiment, the chain-extending diol is 1,6-hexanediol.

According to another specific embodiment, the chain-extending diol is 1,4-cyclohexanedimethanol.

The polymerization reaction can optionally be carried out in the presence of a catalyst. The catalyst can in particular be chosen from organometallic catalysts based on tin, zinc or bismuth. Examples of tin-based catalyst which can be used are in particular the compounds of formula RₙSnXₘ in which R is an alkyl group having between 1 and 10 carbon atoms; X is a carboxylate group resulting from a carboxylic acid having from 1 to 20 carbon atoms; n is equal to 1, 2 or 3; m is equal to 1, 2 or 3; and n+m=4; such as dibutyltin dilaurate or butyltin tris(2-ethylhexanoate). Examples of zinc-based catalyst which can be used are in particular zinc bis(2-ethylhexanoate) and zinc salts of linear or branched fatty acids having from 2 to 20 carbon atoms. An example of bismuth-based catalyst which can be used is in particular bismuth trisneodecanoate. The amount of catalyst used is between 0.001% and 1%, preferably between 0.005% and 0.5%, by weight, with respect to the total weight of the polyol, of the hexamethylene diisocyanate and of the chain-extending diol.

According to a specific embodiment, the thermoplastic polyurethane elastomer of the present invention exhibits a number-average molar mass (Mₙ) of between 10 000 and 100 000 g/mol, preferably between 20 000 and 80 000 g/mol, more preferentially between 40 000 and 60 000 g/mol and more preferentially still between 30 000 and 60 000 g/mol.

The thermoplastic polyurethane elastomer of the present invention consists of rigid segments and of flexible segments. The rigid segments originate from the diisocyanate, the urethane bonds and the chain-extending diol, while the flexible segments originate from the long chain of the polyol.

The content of rigid segments (as %) (weight of diisocyanate+weight of chain-extending diol, with respect to the weight of the polyurethane) can in particular be between 8% and 18%, preferably between 11% and 18%, more preferentially between 12% and 17% and more preferentially still between 13% and 16.5%, and the content of flexible segments (as %) (weight of polyol with respect to the weight of the polyurethane) can in particular be between 82% and 89%, preferably between 83% and 88%, more preferentially between 83.5% and 87%.

In particular, the content of rigid segments can be calculated according to the following formula:

$$\frac{{w}_{d i i s o} + {w}_{diol}}{{w}_{d i i s o} + {w}_{diol} + {w}_{p o lyol}}$$

where:

w_{diiso} is the weight of the hexamethylene diisocyanate;
w_{diol} is the weight of the chain-extending diol; and
w_{polyol} is the weight of the polyol.

According to a specific embodiment, the thermoplastic polyurethane elastomer of the present invention exhibits a glass transition temperature (Tg) of between −70° C. and 0° C., preferably between −65° C. and −10° C., more preferentially between −60° C. and −20° C.

According to a specific embodiment, the thermoplastic polyurethane elastomer of the present invention exhibits a glass transition temperature (Tg) of between 20° C. and 125° C., preferably between 30° C. and 115° C., more preferentially between 35° C. and 105° C.

According to a particularly preferred embodiment, the thermoplastic polyurethane elastomer of the present invention comprises two glass transition temperatures. Thus, the polyurethane can exhibit a first Tg (related to the flexible segments) between −70° C. and 0° C., preferably between −65° C. and −10° C., more preferentially between −60° C. and −20° C., and a second Tg (related to the rigid segments) between 20° C. and 125° C., preferably between 30° C. and 115° C., more preferentially between 35° C. and 105° C.

The thermoplastic polyurethane elastomer of the present invention can in particular exhibit a melting point between 110° C. and 220° C., preferably between 130° C. and 200° C., more preferentially between 140° C. and 180° C.

In addition, the thermoplastic polyurethane elastomer of the present invention can in particular exhibit an enthalpy of fusion between 1 and 10 J/g, preferably between 4 and 10 J/g.

The thermoplastic polyurethane elastomer of the present invention can in particular be used to modify the mechanical properties of an asphalt or of a biobased binder at high or low temperature. Thus, the present invention also relates to a composition comprising a binder, for example asphalt and/or a biobased binder, and the thermoplastic polyurethane elastomer of the invention.

### Composition

The composition of the present invention comprises a binder and the thermoplastic polyurethane elastomer according to the invention described above.

The term “binder” is understood to mean, within the meaning of the present invention, an agglomerating substance, preferably waterproof, which can be in liquid, pasty or powdery form.

The binder introduced into the composition according to the invention can in particular be chosen from an asphalt, a biobased binder and a mixture of these.

The term “biobased binder” is understood to mean, within the meaning of the present invention, a binder, and more particularly an agglomerating substance, preferably waterproof, which entirely or partially results from biomass.

The asphalt which can be introduced into the composition of the present invention is advantageously a straight-run asphalt, also called pure asphalt. Examples of asphalts which can be used are asphalts of the 10/20, 20/30, 35/50, 50/70, 70/100 or 160/220 grades, the grades being defined according to the penetrability of a needle into 100 g of asphalt at 25° C. after 5 seconds, expressed in 1/10th of a mm and measured according to the standard EN 1426 of January 2018.

According to an advantageous embodiment, the asphalt of the composition is an asphalt of 35/50 or 50/70 grade. Such an asphalt is particularly suitable for the preparation of road pavements.

According to an advantageous embodiment, the asphalt of the composition is an asphalt of 70/100 or 160/220 grade. Such an asphalt is particularly suitable for the preparation of waterproofing surfacings.

According to an advantageous embodiment, the asphalt of the composition can be an asphalt which is not very compatible with the polyurethanes of the prior art, such as in particular an asphalt rich in resins. In particular, the asphalt can comprise from 16% to 30%, for example from 18% to 25%, by weight of resins, with respect to the total weight of the SARA (saturates, aromatics, resins and asphaltenes) fractions. More particularly, the asphalt can comprise from 30% to 70% for example from 50% to 58%, by weight of aromatics, with respect to the total weight of the SARA fractions.

The biobased binder which can be introduced into the composition of the present invention can in particular exhibit viscoelastic properties comparable to those of an asphalt. Thus, the biobased binder can exhibit a needle penetrability at 25° C., as measured according to the standard EN 1426 of January 2018, of 10 to 300 1/10th of a mm. In addition, the biobased binder can exhibit a ring and ball temperature, as measured according to the method described below, of 20 to 80° C.

The biobased binder can in particular comprise one or more compounds chosen from an oil, a vegetable resin, a modified vegetable resin, a tall oil pitch, a modified tall oil pitch, a rosin, a fortified rosin, a terpene, a resin acid, a grape marc, a compound extracted from algae or microalgae (lipid and/or saccharide), a fatty acid, a fatty acid ester, a fatty acid methyl ester, lignin, a coumarone-indene resin, a copal resin, a dammar resin, an accroides resin, betaine and the derivatives of these.

The term “derivatives of these” encompasses the compounds obtained by chemical transformation or heat treatment of the abovementioned compounds. Examples of chemical transformations are esterification, hydrogenation, disproportionation, dimerization, polymerization or also a Diels-Alder reaction. Examples of heat treatments are distillation or decarboxylation.

The oil can in particular be an oil of vegetable origin, an oil of animal origin and their mixtures. Within the meaning of the present invention, the term “oil of animal origin” or “oil of vegetable origin” is understood to mean the oils obtained from plants or animals, either directly or after one or more separation and/or chemical transformation stages.

Examples of vegetable oils which can be introduced into the biobased binder are linseed oil, rapeseed oil, sunflower oil, soybean oil, olive oil, palm oil, castor oil, corn oil, grape seed oil, jojoba oil, sesame oil, walnut oil, hazelnut oil, almond oil, shea oil, macadamia oil, cottonseed oil, alfalfa oil, coconut oil, copra oil, safflower oil, peanut oil, squash oil, Chinese wood oil and their mixtures.

Examples of animal oils which can be introduced into the biobased binder are tallow, lard and their mixtures.

The oil can also be chosen from saturated polyester oils, unsaturated polyester oils, vegetable oils having a high content of oleic acid and their mixtures. Within the meaning of the present invention, the term “saturated polyester oil” is understood to mean the product of reaction between a polyol and two, three or four saturated carboxylic acids. Within the meaning of the present invention, the term “unsaturated polyester oil” is understood to mean the product of reaction between a polyol and two, three or four unsaturated carboxylic acids. The polyols which can be used to make saturated or unsaturated polyester oils are 1,1,1-trimethylolpropane, pentaerythritol, ethylene glycol, diethylene glycol, triethylene glycol, tetraethylene glycol, pentaethylene glycol, hexaethylene glycol, glycerol, dipropylene glycol, tripropylene glycol, 1,3-propanediol, 1,4-butanediol, 1,5-pentanediol, 1,6-hexanediol, neopentyl glycol, their ethoxylated and/or propoxylated derivatives, that is to say the abovementioned polyols additionally comprising —(O—CH₂—CH₂)— and/or -(—O—CH(CH₃)—CH₂)— units between the alcohol functional groups, and their mixtures. The saturated carboxylic acids which can be used to make saturated polyester oils are saturated linear or branched carboxylic acids having from 8 to 32 carbon atoms. The unsaturated carboxylic acids which can be used to make unsaturated polyester oils are linear or branched carboxylic acids having from 8 to 32 carbon atoms and from 1 to 6 C═C double bonds. The oil which can be introduced into the biobased binder can in particular be an unsaturated polyester oil. An example of an unsaturated polyester oil is pentaerythritol tetraoleate.

A vegetable resin is a viscous liquid which circulates in the resin canals occurring on the circumference of coniferous trees, such as in particular trees of the Pinus genus. The vegetable resin can be obtained by an operation called tapping which is carried out by removing the bark on a small part of the tree, by making an incision in the wood and by collecting the resin which flows out. The vegetable resin comprises terpenes and resin acids. Examples of terpenes are bicyclic terpenes, such as α-pinene, β-pinene and δ-3-carene; monocyclic terpenes, such as limonene and terpinolene; sesquiterpenes, such as longifolene and caryophyllene; and their mixtures. Examples of resin acids are resin acids such as abietic acid and its isomers, pimaric acid and its isomers, and their mixtures. The mixture of said resin acids, also called colophony or rosin, can be the solid residue obtained after distillation of natural vegetable resin. The main constituents of vegetable resin, that is to say the terpenes and the resin acids, can also be obtained from byproducts resulting from the manufacture of paper pulp by the Kraft process. Thus, the terpenes can be obtained by distillation of the papermaking species at reduced pressure and the rosin by distillation of the tall oil crude at reduced pressure. Within the meaning of the present invention, the term “vegetable resin” comprises the products resulting from the tapping or from the process for the manufacture of paper pulp by the Kraft process, which comprise terpenes and/or resin acids.

Within the meaning of the present invention, the term “modified vegetable resin” comprises the products resulting from the transformation by chemical reaction of natural vegetable resin as defined above. The modified vegetable resin can in particular be a terpene phenolic resin or a fortified rosin ester. Within the meaning of the present invention, the term “terpene phenolic resin” is understood to mean a modified vegetable resin obtained by chemical reaction of a terpene or of a mixture of terpenes with an optionally substituted phenol. Nonlimiting examples of terpenes are monocyclic terpenes, bicyclic terpenes, linear terpenes and the mixtures of these, such as, in particular, α-pinene, β-pinene, δ-3-carene, dipentene, terpinolene, myrcene or allo-ocimene. Within the meaning of the present invention, the term “fortified rosin ester” is understood to mean a modified vegetable resin obtained by esterification reaction of a polyol with a fortified rosin. Nonlimiting examples of polyols suitable for esterifying the fortified rosin are pentaerythritol, 1,1,1-trimethylolpropane, ethylene glycol, diethylene glycol, triethylene glycol, polyethylene glycol, glycerol, dipropylene glycol, tripropylene glycol, 1,3-propanediol, 1,4-butanediol, 1,5-pentanediol, 1,6-hexanediol, neopentyl glycol and their mixtures. Within the meaning of the present invention, the term “fortified rosin” is understood to mean a modified vegetable resin obtained by chemical reaction of Diels-Alder type of a rosin with an α,β-unsaturated compound comprising from one to three groups independently chosen from carboxylic acid (—COOH) and acid anhydride (—C(O)OC(O)—). The fortified rosin thus has a higher softening point than the corresponding rosin. Nonlimiting examples of α,β-unsaturated compounds comprising from one to three groups independently chosen from carboxylic acid (—COOH) and acid anhydride (—C(O)OC(O)—) which are suitable for fortifying rosin are acrylic acid, methacrylic acid, fumaric acid, itaconic acid, sorbic acid, maleic acid and also their anhydride forms.

Tall oil pitch is a byproduct resulting from the manufacture of paper pulp by the Kraft process. Thus, when coniferous wood chips are treated with a mixture of hot sodium hydroxide and sodium sulfide, the lignin and the hemicellulose degrade and dissolve in the liquor, whereas the cellulose can be recovered in pulp form and subsequently washed. The liquor, which also contains acids in the form of sodium carboxylates, is recovered and concentrated. The foam which forms at the surface of the concentrated liquor is recovered and then hot acidified with sulfuric acid to result in tall oil crude. The tall oil crude is subsequently distilled at reduced pressure and the residual nonvolatile fraction is tall oil pitch. Tall oil pitch, referenced under CAS No. 8016-81-7, comprises predominantly fatty acids, such as palmitic acid, linoleic acid and oleic acid; fatty acid esters; resin acids, such as abietic acid and its isomers, pimaric acid, isopimaric acid and sandaracopimaric acid; resin acid esters; diterpene alcohols; fatty alcohols and sterols. The composition of tall oil pitch varies depending on the species of conifer used and its provenance.

Modified tall oil pitch can be obtained by esterification of tall oil pitch with an alcohol, a polyol or a mixture of these. The alcohols and/or polyols used to modify the tall oil pitch can in particular be of vegetable origin. Nonlimiting examples of alcohols which can be used to modify the tall oil pitch are alcohols comprising from 1 to 18 carbon atoms, such as in particular methanol, ethanol, propanol, butanol, terpene alcohols, fatty alcohols, such as lauryl alcohol, myristyl alcohol, cetyl alcohol or stearyl alcohol, and their mixtures. Nonlimiting examples of polyols which can be used to modify the tall oil pitch are terpene polyols, 1,1,1-trimethylolpropane, pentaerythritol, ethylene glycol, diethylene glycol, triethylene glycol, polyethylene glycol, glycerol, dipropylene glycol, tripropylene glycol, 1,3-propanediol, 1,4-butanediol, 1,5-pentanediol, 1,6-hexanediol, neopentyl glycol and their mixtures. The modified tall oil pitch can also be obtained by thermal decarboxylation of tall oil pitch. The thermal decarboxylation of tall oil pitch can in particular be carried out at a temperature of 250 to 450° C., in particular of 275 to 375° C., more particularly of 300 to 360° C.

According to a specific embodiment, the biobased binder can in particular comprise:
from 65% to 85%, preferably from 70% to 80%, more preferentially 75%, of a plasticizing fraction comprising a modified tall oil pitch;
from 15% to 35%, preferably from 20% to 30%, more preferentially 25%, of a structuring fraction comprising a modified vegetable resin;
   the % values being % values by weight, with respect to the weight of the biobased binder.
   Such a biobased binder is described in the patent EP 3 081 599 on behalf of Soprema.

According to another specific embodiment, the biobased binder can in particular comprise:
from 30% to 50%, preferably from 35% to 45%, more preferentially 40%, of a plasticizing fraction comprising an oil;
from 50% to 70%, preferably from 55% to 65%, more preferentially 60%, of a structuring fraction comprising a modified vegetable resin;
   the % values being % values by weight, with respect to the weight of the biobased binder.
   Such a biobased binder is described in the patent EP 3 081 600 on behalf of Soprema.

The composition according to the invention comprises from 3% to 30%, preferably from 5% to 22%, by weight of thermoplastic polyurethane elastomer, with respect to the total weight of the binder and of the thermoplastic polyurethane elastomer.

According to a specific embodiment, the composition comprises from 5% to 13%, in particular from 7% to 12%, more particularly from 9% to 11%, by weight of thermoplastic polyurethane elastomer, with respect to the total weight of the binder and of the thermoplastic polyurethane elastomer. Such a composition is particularly suitable for the preparation of road pavements.

According to another specific embodiment, the composition comprises from 17% to 22%, in particular from 18% to 21%, more particularly from 19% to 20%, by weight of thermoplastic polyurethane elastomer, with respect to the total weight of the binder and of the thermoplastic polyurethane elastomer. Such a composition is particularly suitable for the preparation of waterproofing surfacings.

The composition can additionally comprise a compound chosen from a catalyst, a fatty substance (for example a wax, an oil and/or a fatty acid methyl ester (FAME)), an additive (antioxidant or others), a filler, a second polymer and their mixtures.

The catalyst can in particular be as described above for the polymerization reaction of the thermoplastic polyurethane elastomer. Oils or FAMEs which can be added to the composition are naphthenic oils, such as Ruetasolv® DI or Nytex 820, or FAMEs such as Oleoflux®. Fillers which can be added to the composition are inorganic or organic fillers, such as calcium carbonate, silica, talc, dolomite, kaolin, carbon black and their mixtures. Additives which can be added to the composition are flame retardants, such as colemanite, anti-root agents, such as Preventol® B5, or antioxidants. The second polymer which can be added to the composition is a polymer other than the TPU of the present invention, for example a thermoplastic polymer of the type of block elastomer [SBS or SEBS (styrene/ethylene/butadiene/styrene)] or plastomer [polyolefin of the PPA, EVA (ethylene/vinyl acetate), IPP (isotactic polypropylene), APAO (amorphous poly-α-olefin) or PE (polyethylene) type].

The composition can in particular comprise the following compounds, the percentages being percentages by weight with respect to the total weight of the composition:
from 40% to 90%, preferably from 60% to 80%, of binder;
from 10% to 50%, preferably from 15% to 40%, of thermoplastic polyurethane elastomer according to the invention;
from 0% to 10%, preferably from 0% to 5%, more preferentially from 0% to 3%, of fatty substance;
from 0% to 50%, preferably from 0% to 40%, more preferentially from 0% to 20%, of filler;
from 0% to 20% of additive;
from 0% to 10% of a second polymer; and
from 0% to 0.5% of catalyst.

### Preparation Process

The composition according to the invention can be obtained by synthesizing, first of all, the thermoplastic polyurethane elastomer and by then adding the latter to the hot binder.

According to a first embodiment, the thermoplastic polyurethane elastomer can be synthesized in two stages. In a first stage, all of the polyol is reacted with an excess of the hexamethylene diisocyanate and optionally a catalyst to form a prepolymer and, in the second, the reaction is terminated by adding the chain extender and optionally a catalyst. The first stage can in particular be carried out with stirring under an inert atmosphere for 30 min to 5 hours, at a temperature of 80 to 90° C. The chain extender and the optional catalyst are added to the reactor after this time and the mixture is placed under stirring, for example for 5 to 10 minutes depending on the rate of increase in the viscosity of the mixture. The mixture can subsequently be poured into a mold or onto a plate and then cured. The curing can be carried out in an oven, for example at 100° C. for 20 hours. Alternatively, the curing can be carried out in an oven, for example at 80° C. for 12 hours, then under a press, for example at 110° C. for 1 hour. The polymer can then be cooled and optionally cut into granules.

According to a second embodiment, the thermoplastic polyurethane elastomer can be obtained by reactive extrusion. Reactive extrusion consists in carrying out the polymerization reaction of the thermoplastic polyurethane elastomer in an extruder. The extruders are composed mainly of one or more endless screws which rotate inside a barrel, thus making possible mixing of the polymers introduced.

Within the meaning of the present invention, the term “extruder” includes the following items of equipment: single-screw extruders, multi-screw extruders, such as in particular co- or counterrotating twin-screw extruders, planetary extruders, annular extruders and static or intensive mixers. According to a preferred embodiment, the extruder used in the process of the invention is a corotating twin-screw extruder.

The synthesis of the thermoplastic polyurethane elastomer by reactive extrusion can in particular comprise the following stages:
introduction of the polyol, of the hexamethylene diisocyanate, of the chain extender and optionally of the catalyst into an extruder,
cutting of the extrudate into granules at the outlet of the extruder.

According to a specific embodiment, the polyol can be heated before it is introduced into the extruder. For example, the polyol can be heated to a temperature of between 60 and 150° C.

The stage of introduction of the polyol, the hexamethylene diisocyanate, the chain-extending diol and optionally the catalyst into the extruder can be carried out in several ways. Each reactant can be introduced into the extruder separately, or else all the reactants can be mixed together beforehand and then introduced into the extruder, or else some reactants are introduced separately and others are mixed together beforehand before being introduced into the extruder. Preferably, the polyol and the hexamethylene diisocyanate are introduced separately and the chain-extending diol is introduced as a mixture with the catalyst.

The flow rate of each reactant or reactant mixture introduced into the extruder can advantageously be controlled with metering pumps.

The polymer obtained according to the first or the second embodiment, for example in the form of granules, is added to the binder preheated to a temperature greater than its melting point, for example to a temperature of 20 to 180° C. The mixture can be placed under mechanical stirring, for example for 5 to 45 minutes at a temperature of 20 to 180° C.

According to a third embodiment, the composition can be obtained by synthesizing, first of all, a prepolymer by reaction of the polyol and of the hexamethylene diisocyanate, optionally in the presence of a catalyst, and by then adding the latter to the hot binder in the presence of the chain-extending diol (prepolymer route). The synthesis of the prepolymer can in particular be carried out with stirring under an inert atmosphere for 30 minutes to 5 hours, at a temperature of 80 to 90° C. The prepolymer is subsequently introduced into the binder heated to a temperature greater than its melting point, for example to a temperature of 20 to 180° C., so as to obtain a fluid and homogeneous mass. The chain-extending agent and optionally a catalyst are subsequently added. Depending on the polyols used, the amount of catalyst and the temperature of the mixture, the reaction time varies between 15 and 120 minutes, during which the resulting mixture is heated intermittently or continuously, until polymerization. The final temperature of the binder can reach 20 to 180° C. in order to make possible complete polymerization and to have a sufficiently fluid mass.

According to a fourth embodiment, the composition can be obtained by carrying out the synthesis of the thermoplastic polyurethane elastomer directly in the hot binder (one-shot process). In this process, the binder is brought to its melting point, for example to a temperature of 20 to 180° C. The polyol, the hexamethylene diisocyanate and optionally a catalyst are added and the mixture is stirred for a certain period of time, for example between 60 and 120 minutes. The chain-extending agent and optionally a catalyst are then added. The temperature of the final mixture obtained is gradually increased, for example up to 180° C., with intermittent or continuous stirring, in order to retain a fluid mass and to make possible complete polymerization.

The fatty substance (wax, oil and/or FAME) and/or the filler and/or the additive and/or the second polymer, which is (are) optional, can be added before, during or after the synthesis of the thermoplastic polyurethane elastomer, but also during or after the introduction of the thermoplastic polyurethane elastomer into the hot binder. Preferably, said optional compounds are added after the addition or the synthesis of the thermoplastic polyurethane elastomer.

### Uses

The composition according to the invention can be used for the preparation of a waterproofing membrane, of a soundproofing membrane, of a liquid waterproofing system, of a roadway pavement (for example a bituminous mix, a biobased binder mix or a mastic asphalt), of a primer, of a varnish, of a mastic, of an adhesive or of a binder emulsion.

According to a specific embodiment, the composition of the present invention is deposited on a fibrous support to form a prefabricated waterproofing membrane. The composition can in particular be deposited on the fibrous support by coating, for example with a scraper, and then the fibrous support can be impregnated to the core with the composition, for example by passing the coated fibrous support through a calender roll.

The waterproofing membrane obtained is provided in particular in the form of a roll which can be unwound over the surface to be waterproofed and the different strips of membranes are then welded together with a welding torch or else with hot air.

According to another embodiment, the composition of the present invention is used as road mix binder.

The invention will be described in more detail with the help of the following examples, which are given purely by way of illustration.

### EXAMPLES

In the description and the examples below, the following methods were used to measure the glass transition temperature, the melting point, the enthalpy of fusion, the rubbery plateau modulus, the ring and ball temperature, the needle penetrability, the elastic recovery, the viscosity and the Fraass breaking point.

Thermal Properties

The measurement of the glass transition temperature, the melting point and the enthalpy of fusion are carried out by differential scanning calorimetry (DSC) by performing the following cycles at 10° C./min:
Cycle 1: rise in temperature from −80° C. up to 250° C.;
Cycle 2: fall in temperature down to −80° C.;
Cycle 3: rise in temperature up to 250° C.
The parameters are measured during the 3rd cycle.

Thermomechanical Properties

The measurement of the rubbery plateau modulus (G′) is carried out by dynamic mechanical analysis (DMA) in torsion. The torsional stress is generated by the interaction between a magnet and Helmholtz coils which are traversed by a sinusoidal current and transmitted by means of a rigid rod placed at the end of the sample. The angular deformation is measured by an optical system of laser diode and of reflective target. A sample 2 mm thick, 6 mm wide and approximately 12 mm long is introduced into the center of a temperature-controlled oven and the assembly is placed under an inert atmosphere with helium at a pressure of 600 mbar. The test is carried out between −120 and 130° C. at a frequency of 1 Hz with a gradient of 1° C. min⁻¹.

Ring and Ball Temperature (RBT)

The measurements were carried out in accordance with the standard NF EN 1427 (January 2018): Determination of the softening point—Ring and Ball method. This method makes it possible to characterize the thermal susceptibility at high temperature of a binder.
To carry out this test, a steel ball is placed on a copper ring filled beforehand with binder. The assembly is immersed in a bath, the temperature of which is raised by 5° C. per minute. The softening point or the ring and ball temperature is that at which the ball, carrying along the binder membrane, reaches a given mark 2.5 cm lower. The temperature recorded when this condition is fulfilled is the ring and ball softening point and this corresponds to the upper limit of use of the binder.

Needle Penetrability at 25° C. (Pene)

The measurements were carried out in accordance with the standard NF EN 1426 (January 2018): Determination of needle penetrability. The penetrability makes it possible to determine the hardness of a binder and thus to classify it into different grades.
The penetrability is the measurement of the penetration into a sample of binder after 5 seconds of a needle, the weight of which with its support and an additional load is 100 g. It is expressed in 0.1 mm. Three measurements are carried out per binder at different points of the sample container.

Elastic Recovery

The elastic recovery is measured according to the standard EN 13398 (December 2017) in a ductilometer at 25° C. The material to be tested is stretched to undergo an elongation of 200 mm. The value of the elastic recovery is the percentage of length of retraction of the material reduced to its total length. A level of elastic recovery of 100% corresponds to a material which completely recovers its original dimensions.

Viscosity

The dynamic viscosity makes it possible to describe the rheological behavior of a binder. It is determined according to the standard NF EN 13302 (June 2018) using a rotating viscometer (speed between 0.3 and 60 rpm) and corresponds to the ratio of the applied shear stress to the shear rate. For this measurement, a torque is applied to a rotor (cylinder) rotating in a container containing the binder to be measured. This torque measures the relative resistance of the rotor to the rotation and thus determines the dynamic viscosity of the asphalt at a predetermined temperature. It is generally measured at 160° C.

Fraass Breaking Point

The measurements were carried out in accordance with the standard NF EN 12593 (June 2007): Determination of the Fraass breaking point. The Fraass breaking point corresponds to the cracking temperature of the binder at low temperature.
To determine this temperature, a sample of binder (w=410±10 mg) is spread over a steel blade according to a uniform thickness. This blade is subjected to continuous cooling (1° C./min) and bent repeatedly (1 bend/min) until the binder layer cracks.

The apparatus detects the crack when the bending energy decreases. The temperature at which the first cracking occurs is noted as the Fraass breaking point.

In the examples, the following constituents were used:

Polyol:
polyester polyol comprising a C₃₄ chain (of C₁₈ fatty acid dimer type) having a number-average molar mass of 3000 g/mol sold under the commercial reference Radia® 7285 by Oleon

Chain-Extending Diol:
1,4-butanediol (subsequently referred to as BDO)
1,6-hexanediol (subsequently referred to as HDO)
1,4-cyclohexanedimethanol (subsequently referred to as CHDM)

Diisocyanate:
1,6-hexamethylene diisocyanate sold under the commercial reference hexamethylene diisocyanate by Merck (subsequently referred to as HDI)
4,4′-diphenylmethane diisocyanate sold under the commercial reference Suprasec® 1306 by Huntsman (subsequently referred to as MDI)

Catalyst:
dibutyltin dilaurate sold under the commercial reference Dabco® T-12N by Air Products

Asphalt:
asphalt 1: asphalt of 160/220 grade sold under the commercial reference B200K by the refinery of Karlsruhe (Germany)
asphalt 2: asphalt of 50/70 grade resulting from the refinery of Lavera (France)

### Example 1: Preparation of a TPU

The TPUs were prepared using the reactants and the amounts (parts by weight) listed in [Table 1].

TPU 1 was prepared by a one-shot process. First of all, the polyol, the diisocyanate and 0.01% by weight of catalyst, with respect to the total weight of the polyol, of the diisocyanate and of the chain-extending diol, were mixed. The mixture was heated at 80° C. for 4 hours under a nitrogen flow. Then, the chain extender was added to the reaction mixture and stirred for 5 to 10 minutes. The polymer was subsequently poured into a metal air gap to undergo curing at 80° C. for 12 h in an oven and then placed under a press at 110° C. for 1 h with the aim of obtaining a sheet with a thickness of 2 mm.

TPUs 2-8 were prepared by reactive extrusion. The extruder used to prepare the granules was of corotating twin-screw type having a diameter of 32 mm and a Length/Diameter ratio=80.

The operating conditions were as follows:
The polyol was stored at 80° C. for 48 hours. The polyol was introduced at the inlet of the extruder with a pump with a volume of 12 cm³/revolution.
The chain extender was dehydrated beforehand at 120° C. for 30 min under vacuum and then mixed with 150 ppm of catalyst. The mixture was placed in a vessel with stirring and under argon and introduced at the inlet of the extruder using a pump.
The MDI was melted beforehand at 70° C. The HDI was used as is. The diisocyanate was introduced into the extruder, just after the mixture of polyol and of chain extender, using a pump.
At the extruder outlet, a gear pump facilitated the exit of the material. The polymer was cooled in water to 10° C. before being granulated with an SHD-50 granulator.
   Table 1 below shows the content of hard segments and the NCO/OH ratio which are obtained. The flow rates of each constituent were adjusted in order to obtain the contents of hard segments and the NCO/OH ratios shown. The flow rates were checked with a flow meter.

TABLE 1

| | | | Chain | | |
|---|---|---|---|---|---|
| | Polyol | Diisocyanate | extender | % Rigid | NCO/OH |
| Test No. | (parts) | (parts) | (parts) | segments | ratio |
| TPU 1 | Radia ® 7285 | HDI | BDO | 13% | 1 |
| | (0.46) | (1) | (0.54) | | |
| TPU 2 | Radia ® 7285 | HDI | HDO | 13% | 1 |
| | (0.487) | (1) | (0.513) | | |
| TPU 3 | Radia ® 7285 | HDI | CHDM | 13% | 1 |
| | (0.51) | (1) | (0.49) | | |
| TPU 4 | Radia ® 7285 | HDI | BDO | 17% | 1 |
| | (0.352) | (1) | (0.648) | | |
| TPU 5 | Radia ® 7285 | HDI | HDO | 17% | 1 |
| | (0.375) | (1) | (0.625) | | |
| TPU 6 | Radia ® 7285 | HDI | CHDM | 17% | 1 |
| | (0.397) | (1) | (0.603) | | |
| TPU 7 | Radia ® 7285 | MDI | BDO | 13% | 0.98 |
| (comparative) | (0.61) | (1) | (0.41) | | |
| TPU 8 | Radia ® 7285 | MDI | BDO | 17% | 0.98 |
| (comparative) | (0.467) | (1) | (0.553) | | |

The thermal properties of the TPUs are combined in [Table 2]. Tg corresponds to the glass transition temperature (FS corresponds to the Tg related to the flexible segments and RS corresponds to the Tg related to the rigid segments). M.p. corresponds to the melting point. AH corresponds to the enthalpy of fusion.

TABLE 2

| Test No. | Composition | Tg (° C.) | M.p. (° C.) | ΔH (J/g) |
|---|---|---|---|---|
| TPU 1 | Radia ® 7285 | −48 (FS) | 157 | 1.2 |
| | HDI | 98 (RS) | 174 | 0.8 |
| | BDO | | | |
| | 13% RS | | | |
| TPU 2 | Radia ® 7285 | −44 (FS) | 148 | 7.7 |
| | HDI | 103 (RS) | 164 | 0.6 |
| | HDO | | | |
| | 13% RS | | | |
| TPU 4 | Radia ® 7285 | −58 (FS) | 156 | 1.8 |
| | HDI | 98 (RS) | 176 | 2.5 |
| | BDO | | | |
| | 17% RS | | | |
| TPU 5 | Radia ® 7285 | −58 (FS) | 157 | 12.3 |
| | HDI | 36 (RS) | | |
| | HDO | | | |
| | 17% RS | | | |
| TPU 7 | Radia ® 7285 | −54 | 170 | 0.1 |
| (comparative) | MDI | | 187 | |
| | BDO | | | |
| | 13% RS | | | |
| TPU 8 | Radia ® 7285 | −54 (FS) | 209 | 0.50 |
| (comparative) | MDI | 103 (RS) | | |
| | BDO | | | |
| | 17% RS | | | |

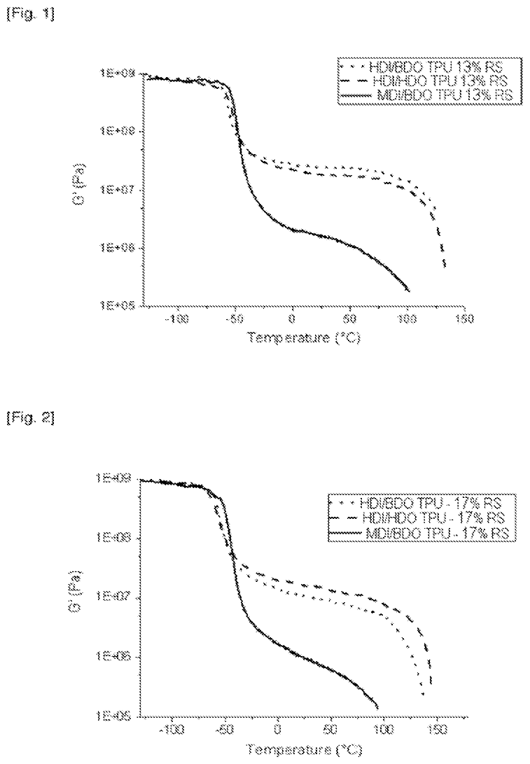

The rubbery plateau modulus (G′) of TPUs 1, 2 and 7 is represented in [FIG. 1]. The rubbery plateau modulus (G′) of TPUs 4, 5 and 8 is represented in [FIG. 2].

At a content of rigid segments of 13%, the TPU according to the invention exhibits a Tg related to the flexible segments which is higher than that of the MDI-based TPU. This can be explained by an increase in the amount of rigid segments dissolved in the flexible phase. In addition, the MDI-based TPU comprising 13% of rigid segments does not exhibit a true rubbery plateau above the Tg of the flexible phase, but rather a slow and steady decline in the modulus preceding the flow phase beyond 80-100° C. This is because it contains too few rigid segments and these have too low a Tg, because of their very low mean length, to be able to constitute true rigid nanodomains which can play the role of crosslinking node up to sufficiently high temperatures, unlike the rigid segments based on HDI which, being largely crystalline, play this role up to their melting point.

At a comparable content of rigid segments, the TPU according to the invention exhibits a lower melting point and a higher enthalpy of fusion than an MDI-based TPU. This is explained by a greater size of the crystalline entities. In this case, the rubbery flow of the polymer takes place after the melting (M.p) of the crystalline entities.

At a comparable content of rigid segments, FIGS. 1 and 2 show that the TPU according to the invention exhibits a much higher and broader rubbery plateau modulus than an MDI-based TPU [cf. TPUs 1 and 2 (according to the invention) compared with TPU 7 (comparative) and TPUs 4 and 5 (according to the invention) compared with TPU 8 (comparative)]. Without wishing to be committed to any one theory, this result might be explained by the symmetrical structure (in space) of the diisocyanate HDI making possible a better organization of the segments and thus a higher crystallinity for the TPU in comparison with the diisocyanate MDI.

The TPU of the invention is distinguished from the TPU prepared with MDI by virtue of the formation of rigid segments exhibiting excellent symmetry. This results in an increase in the crystallinity of the TPU. A homogeneous distribution of the nodules of rigid segments in the flexible phase, which are organized in the form of a network, is observed at 13% of rigid segments. This results in a TPU being obtained which has a very high rubbery plateau modulus, with a broad rubbery plateau.

### Example 2: Preparation of a Composition Comprising a TPU and Asphalt

In a thermostatically-controlled kneader, compositions were prepared with the percentages by weight described in [Table 3] according to the following process: the asphalt was heated to 170° C., the TPU granules were introduced and mixing was carried out at a temperature of 170° C.-175° C. for 15-20 min with stirring between 1500 and 2000 rpm. The mixture is then cast in the form of sheets before being cooled to ambient temperature.

TABLE 3

| | Ingredients |
|---|---|
| Test No. | (% by weight) |
| Composition 1 | Asphalt 1 (77%) |
| | TPU 1 (23%) |
| Composition 2 | Asphalt 1 (77%) |
| | TPU 2 (23%) |
| Composition 3 | Asphalt 1 (70%) |
| (comparative) | TPU 7 (30%) |
| Composition 4 | Asphalt 1 (77%) |
| | TPU 4 (23%) |
| Composition 5 | Asphalt 1 (77%) |
| | TPU 5 (23%) |
| Composition 6 | Asphalt 1 (77%) |
| (comparative) | TPU 8 (30%) |

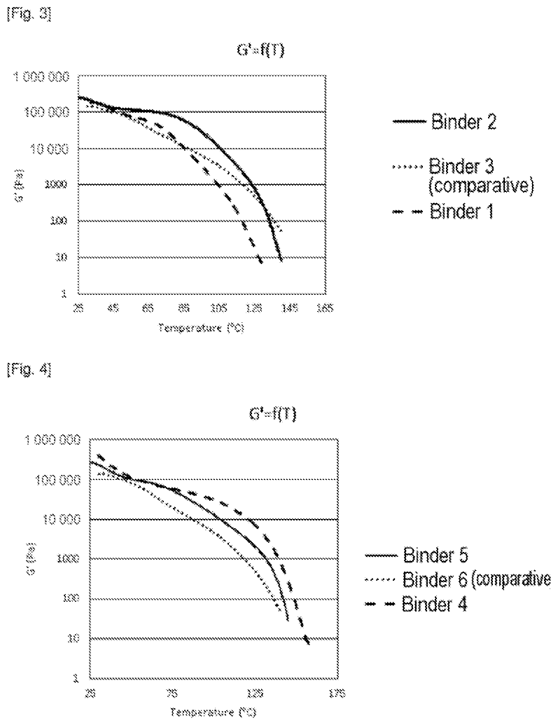

The thermomechanical properties of compositions 1-3 and compositions 4-6 are represented respectively in [FIG. 3] and [FIG. 4].

At a content of rigid segments of 13%, composition 2 (based on HDI and on HDO) exhibits the highest rubbery plateau modulus. Compositions 1 and 2 exhibit better mechanical properties than composition 3 (comparative based on MDI and on BDO) whereas they contain less TPU.

At a content of rigid segments of 17%, composition 4 (based on HDI and on BDO) exhibits the highest rubbery plateau modulus. Compositions 4 and 5 exhibit better mechanical properties than composition 6 (comparative based on MDI and on BDO) whereas they contain less TPU.

### Example 3: Preparation of a TPU

The TPUs were prepared using the reactants and the amounts (parts by weight) listed in [Table 4] according to the reactive extrusion process described in example 1.

TABLE 4

| | Diiso- | Chain | | | |
|---|---|---|---|---|---|
| | cyanate | extender | Polyol | | NCO/ |
| | (% by | (% by | (% by | % Rigid | OH |
| Test No. | weight) | weight) | weight) | segments | ratio |
| TPU 9 | HDI | BDO | Radia ® 7285 | 17% | 1 |
| | (12.56) | (4.44) | (83) | | |
| TPU 10 | HDI | BDO | Radia ® 7285 | | 0.98 |
| | (12.5) | (4.5) | (83) | | |
| TPU 11 | HDI | CHDM | Radia ® 7285 | | |
| | (11.3) | (5.7) | (83) | | |
| TPU 12 | HDI | CHDM | Radia ® 7285 | | |
| | (9.3) | (3.7) | (87) | | |
| TPU 13 | HDI | CHDM | Radia ® 7285 | | |
| | (15.5) | (9.6) | (74.9) | | |
| TPU 14 | HDI | CHDM | Radia ® 7285 | | |
| | (12.9) | (7.1) | (80) | | |
| TPU 15 | MDI | CHDM | Radia ® 7285 | | |
| (comparative) | (13.2) | (3.8) | (83) | | |
| TPU 16 | MDI | CHDM | Radia ® 7285 | | 0.98 |
| (comparative) | (13.1) | (3.9) | (83) | | |
| TPU 17 | HDI | / | Radia ® 7285 | / | |
| (comparative) | (4.87) | | (95.13) | | |
| TPU 18 | HDI | HDO | Radia ® 7285 | | |
| | (11.75) | (5.22) | (83) | | |

### Example 4: Preparation of a Composition Comprising a TPU and Asphalt

In a thermostatically-controlled kneader, compositions were prepared with the percentages by weight described in [Table 5] to [Table 14] according to the following process: the asphalt was heated to 170° C., the TPU granules were introduced and mixing was carried out at a temperature of 170° C.-175° C. for 15-20 min with stirring between 1500 and 2000 rpm. The mixture is then cast in the form of sheets before being cooled to ambient temperature.

TABLE 5

| | Ingredients |
|---|---|
| Test No. | (% by weight) |
| Composition 7 | Asphalt 2 (93%) |
| | TPU 9 (7%) |
| Composition 8 | Asphalt 2 (91%) |
| | TPU 9 (9%) |
| Composition 9 | Asphalt 2 (89%) |
| | TPU 9 (11%) |
| Composition 10 | Asphalt 2 (87%) |
| | TPU 9 (13%) |
| Composition 11 | Asphalt 2 (85%) |
| | TPU 9 (15%) |

TABLE 6

| | Ingredients |
|---|---|
| Test No. | (% by weight) |
| Composition 12 | Asphalt 2 (93%) |
| | TPU 10 (7%) |
| Composition 13 | Asphalt 2 (91%) |
| | TPU 10 (9%) |
| Composition 14 | Asphalt 2 (89%) |
| | TPU 10 (11%) |
| Composition 15 | Asphalt 2 (87%) |
| | TPU 10 (13%) |

TABLE 7

| | Ingredients |
|---|---|
| Test No. | (% by weight) |
| Composition 16 | Asphalt 2 (91%) |
| | TPU 11 (9%) |
| Composition 17 | Asphalt 2 (89%) |
| | TPU 11 (11%) |
| Composition 18 | Asphalt 2 (87%) |
| | TPU 11(13%) |

TABLE 8

| | Ingredients |
|---|---|
| Test No. | (% by weight) |
| Composition 19 | Asphalt 2 (91%) |
| | TPU 12 (9%) |
| Composition 20 | Asphalt 2 (89%) |
| | TPU 12 (11%) |
| Composition 21 | Asphalt 2 (87%) |
| | TPU 12(13%) |

TABLE 9

| | Ingredients |
|---|---|
| Test No. | (% by weight) |
| Composition 22 | Asphalt 2 (91%) |
| | TPU 13 (9%) |
| Composition 23 | Asphalt 2 (89%) |
| | TPU 13 (11%) |
| Composition 24 | Asphalt 2 (87%) |
| | TPU 13 (13%) |

TABLE 10

| | Ingredients |
|---|---|
| Test No. | (% by weight) |
| Composition 25 | Asphalt 2 (91%) |
| | TPU 14 (9%) |
| Composition 26 | Asphalt 2 (89%) |
| | TPU 14 (11%) |
| Composition 27 | Asphalt 2 (87%) |
| | TPU 14 (13%) |

TABLE 11

| | Ingredients |
|---|---|
| Test No. | (% by weight) |
| Composition 28 | Asphalt 2 (91%) |
| (comparative) | TPU 15 (9%) |
| Composition 29 | Asphalt 2 (89%) |
| (comparative) | TPU 15 (11%) |
| Composition 30 | Asphalt 2 (87%) |
| (comparative) | TPU 15 (13%) |

TABLE 12

| | Ingredients |
|---|---|
| Test No. | (% by weight) |
| Composition 31 | Asphalt 2 (91%) |
| (comparative) | TPU 16 (9%) |
| Composition 32 | Asphalt 2 (89%) |
| (comparative) | TPU 16 (11%) |
| Composition 33 | Asphalt 2 (87%) |
| (comparative) | TPU 16 (13%) |

TABLE 13

| | Ingredients |
|---|---|
| Test No. | (% by weight) |
| Composition 34 | Asphalt 2 (91%) |
| (comparative) | TPU 17 (9%) |
| Composition 35 | Asphalt 2 (89%) |
| (comparative) | TPU 17 (11%) |
| Composition 36 | Asphalt 2 (87%) |
| (comparative) | TPU 17 (13%) |

TABLE 14

| | Ingredients |
|---|---|
| Test No. | (% by weight) |
| Composition 37 | Asphalt 2 (91%) |
| | TPU 18 (9%) |
| Composition 38 | Asphalt 2 (89%) |
| | TPU 18 (11%) |
| Composition 39 | Asphalt 2 (87%) |
| | TPU 18 (13%) |

The properties of the compositions are described in detail in the tables below. RBT corresponds to the ring and ball temperature (EN 1427). Pene corresponds to the needle penetrability measured at 25° C. (EN 1426). The elastic recovery (EN 13398) is measured at 25° C. (R corresponds to rupture). Viscosity corresponds to the Brookfield viscosity measured at 160° C. (internal method). Fraass breaking corresponds to the Fraass breaking point (EN 12593).

Nature of the Diisocyanate:

The impact of the nature of the isocyanate is demonstrated by the results of compositions 16-18 (HDI) compared with compositions 28-30 (MDI) in [Table 14].

TABLE 14

| | | Pene | Elastic | | Fraass |
|---|---|---|---|---|---|
| | RBT | (1/10 | recovery | Viscosity | breaking |
| Test No. | (° C.) | mm) | (%) | (poises) | (° C.) |
| Composition 16 | 56.4 | 43 | 42 | 3.6 | −16 |
| Composition 17 | 67.6 | 41 | 53 | 4.4 | −18 |
| Composition 18 | 122 | 33 | R | 5.4 | −19 |
| Composition 28 | 65 | 50 | 64 | 3.4 | −16 |
| (comparative) | | | | | |
| Composition 29 | 69.8 | 50 | 74 | 4.1 | −16 |
| (comparative) | | | | | |
| Composition 30 | 73.4 | 45 | 86 | 4.9 | −19 |
| (comparative) | | | | | |

1. Penetrability: the consistency of the compositions increases with the content of TPU introduced. In addition, the isocyanate HDI brings about mixtures with a higher consistency at an equivalent polymer content (at 11% of polymer, for example, penetrability of 41 1/10 mm for HDI versus 50 1/10 mm for MDI).
2. RBT: the RBT increases with the content of TPU. This increase is steady for MDI (the RBT changes from 65° C. to 73.6° C. between 9% and 13% of polymer), unlike HDI, for which a strong increase is observed between 11% and 13% of polymer (+55° C.).
3. Fraass breaking: the cold resistance values are similar for all the compositions (type of TPU and percentage of polymer introduced). They are between −16 and −19° C.
4. Elastic recovery: the percentage of elastic recovery increases with the amount of polymer introduced. In the case of the composition comprising 13% of MDI TPU, the values reached are comparable to those of a Biprene® 65 (elastic recovery of 85%). For HDI, the ER is lower (53% at 11% of TPU) and the test specimen at 13% of polymer breaks (the working zone is so fine that the force necessary for the elongation is regarded as zero by the machine).
5. Viscosity: it increases with the content of TPU and seems close for all the mixtures despite the different chemical structures of the polymers considered.
According to the RBT results, the phase inversion of the HDI TPU lies between 11% and 13% of polymer. As regards the MDI, the steady change in the RBT makes it possible to affirm that the phase inversion is not effective. These results show that HDI is the most efficient for the targeted application: it stiffens the composition and confers on it a reduced thermal susceptibility at high temperature. Coupled with CHDM, it brings about an elasticity/stiffness compromise which is particularly advantageous for road applications. In addition, as the viscosity of the mixtures remains low, it makes it possible to envisage good pumpability of the compositions during their transfer and employment.

Nature of the Chain-Extending Diol:

The impact of the nature of the chain-extending diol is demonstrated by the results of compositions 7-11 (BDO), 16-18 (CHDM), 34-36 (no chain extender) and 37-38 (HDO) in [Table 15].

TABLE 15

| | | Pene | | | Fraass |
|---|---|---|---|---|---|
| | RBT | (1/10 | Elastic recovery | Viscosity | breaking |
| Test No. | (° C.) | mm) | (%) | (poises) | (° C.) |
| Composition 8 | 79.6 | 34 | R | 3.7 | −16 |
| Composition 9 | 122 | 26 | R | 4.5 | −17 |
| Composition 10 | 97.8/129 | 30 | R | 4.7 | −18 |
| | 56.4 | 43 | 42 | 3.6 | −16 |
| Composition 17 | 67.6 | 41 | 53 | 4.4 | −18 |
| Composition 18 | 122 | 33 | R | 5.4 | −19 |
| Composition 34 | 50.6 | 88 | R | 3.4 | −18 |
| (comparative) | | | | | |
| Composition 35 | — | — | — | — | — |
| (comparative) | | | | | |
| Composition 36 | 61.8 | 108 | R | 4.6 | −21 |
| (comparative) | | | | | |
| Composition 37 | 58 | 37 | R | 3.4 | −16 |
| Composition 38 | 72.6 | 31 | R | 4.2 | −17 |
| Composition 39 | 132 | 28 | R | 5.1 | −19 |

1. Penetrability: the chain extenders can be classified according to the consistency which they confer on the compositions comprising 9% and 11% of polymer: BDO is the most rigid, followed by HDO and then by CHDM. However, at 13% of TPU, this trend is not borne out because the penetrability values are similar for all the chain extenders (of the order of 30 1/10 mm).
2. RBT: at 9% and 11% of polymer, the RBT of the composition comprising BDO (120° C. at 11%) is higher than that of HDO and of CHDM (at 11%, approximately 70° C.). At 13% of TPU, the RBT results are equivalent for all the compositions. As regards the change in the RBT values, a strong increase is observed between 9% and 11% for BDO (+42° C.). For HDO (+50° C.) and CHDM (+54° C.), this change lies between 11% and 13% of TPU in the asphalt.
3. Fraass breaking: the Fraass breaking temperature of the compositions is between −16 and −19° C., whatever the nature of the extender and the content of TPU introduced.
4. Elastic recovery: the compositions comprising BDO and HDO snap before the 200 mm of stretching of the test specimens necessary for carrying out the test. The greater the content of TPU in the asphalt, the more the rupture occurs at a low elongation. The remarks regarding CHDM are identical to those of the preceding section (influence of the diisocyanate).
5. Viscosity: it increases with the content of TPU but remains close for all the chain extenders (3.5 Po at 9%, 4.4 Po at 11% and 5 Po at 13%). These viscosity values remain low compared with those of the compositions highly concentrated in SBS (9 Po for 7% of SBS).
BDO (aliphatic chain extender) brings about more consistent/rigid compositions, which impacts their elastic properties (premature rupture of the Elastic Return test specimens). The phase inversion is effective between 9% and 11% of polymer in the asphalt (significant increase in the RBT). Thus, from 11% of TPU, the compositions comprising BDO have performance qualities close to those of an Orthoprene® (except in terms of elasticity). However, it is important to note the great heterogeneity of the mixtures.

HDO (aliphatic chain extender) brings about, just like BDO, which has a similar chemical structure, a rigid composition lacking in elasticity. Its phase inversion is effective between 11% and 13% (at higher contents than BDO).

CHDM (cycloaliphatic chain extender) combines both performance qualities at high temperature and elasticity. At 13% of TPU, the mixture exhibits an RBT of greater than 100° C., which suggests a good creep strength. The characteristics of this composition bring it closer to an Orthoprene® for a content of polymer in the asphalt amounting to 13%. However, its elasticity remains reduced.

Impact of the Percentage of Rigid Segments:

The impact of the percentage of rigid segments is demonstrated by the results of compositions 19-21 (13%), 16-18 (17%), 25-27 (20%) and 22-24 (25%) in [Table 16].

TABLE 16

| | | Pene | Elastic | | Fraass |
|---|---|---|---|---|---|
| | RBT | (1/10 | recovery | Viscosity | breaking |
| Test No. | (° C.) | mm) | (%) | (poises) | (° C.) |
| Composition 19 | 55.8 | 52 | 46 | 3.6 | −17 |
| Composition 20 | 104.5 | 48 | 53 | 4.5 | −18 |
| Composition 21 | 118 | 47 | 62 | 5.1 | −20 |
| Composition 16 | 56.4 | 43 | 42 | 3.6 | −16 |
| Composition 17 | 67.6 | 41 | 53 | 4.4 | −18 |
| Composition 18 | 122 | 33 | R | 5.4 | −19 |
| Composition 25 | 60.8 | 40 | 30 | 3.5 | −16 |
| Composition 26 | 104.5 | 34 | 62 | 4.2 | −17 |
| Composition 27 | 126.7/122.9 | 32 | 64 | 5.3 | −18 |
| Composition 22 | 76.4/80.2 | 33 | R | 3.9 | −16 |
| Composition 23 | 101.5 | 30 | R | 4.3 | −16 |
| Composition 24 | 120.5 | 29 | R | 5 | −19 |

1. Penetrability: the higher the RS content of the TPU and the higher the amount of polymer introduced, the more consistent the composition (progressive increase in the penetrability value).
2. RBT: the RBT increases with the RS content for mixtures comprising 9% of polymer. At 11% and 13% of TPU, the results are similar for all mixtures between 13% and 20% of RS (between 100 and 105° C. at 11% and approximately 120° C. at 13%). Only the composition comprising 25% of RS exhibits a higher RBT (116° C. at 11% of TPU). A significant increase in the softening point of the compositions is observed between 9% and 11% of polymer in the asphalt, except for the 17% RS TPU mixture, for which it takes place between 11% and 13% of polymer.
3. Fraass breaking: the cold Fraass breaking is equivalent for all the contents of rigid segments, the results are between −16 and −20° C. The impact of the amount of TPU is thus not significant.
4. Elastic recovery: it is difficult to show a correlation between RS content and percentage of elastic recovery.
5. Viscosity: the conclusions are identical to those in the preceding sections.
The impact of the content of rigid segments is noteworthy for the compositions where the phase inversion is not effective, that is to say for mixtures comprising 9% of polymer. For the compositions comprising 11% and 13%, the RBT and Fraass breaking results are equivalent.

### INDUSTRIAL APPLICATION

The present technical solutions can be applied in particular in road pavements and the waterproofing of civil engineering works and buildings.

The invention is not limited to the examples of thermoplastic polyurethane elastomers and of compositions described above, only by way of example, but it encompasses all the alternative forms which a person skilled in the art may envisage in the context of the desired protection.

1. A thermoplastic polyurethane elastomer obtained by reaction between:
a polyol comprising a linear or branched C₁₂-C₆₀, preferably C₂₄-C₅₀, more preferentially C₃₀-C₄₀, chain, said polyol having a functionality of between 1.75 and 2.2, preferably between 1.85 and 2.1, more preferentially between 1.95 and 2.05, and a number-average molecular weight (Mₙ) of between 500 and 6000 g/mol, preferably between 900 and 5000 g/mol, more preferentially between 1500 and 3500 g/mol;
hexamethylene diisocyanate; and
a chain-extending diol chosen from 1,4-butanediol, 1,6-hexanediol, 1,4-cyclohexanedimethanol and their mixtures;
with an NCO/OH ratio of between 0.95 and 1.1, preferably between 0.97 and 1.02, more preferentially between 0.98 and 1; and
the content of rigid segments being between 8% and 18%, preferably between 11% and 18%, more preferentially between 12% and 17% and more preferentially still from 13% to 16.5%.

2. The thermoplastic polyurethane elastomer as claimed in claim 1, in which the polyol is a polyester polyol; preferably, the polyol is a polyester polyol formed by reaction between:
a linear or branched dicarboxylic acid comprising from 12 to 60, preferably from 24 to 50, more preferentially from 30 to 40, carbon atoms between the acid functional groups; and
a diol comprising from 2 to 12, preferably from 3 to 10, more preferentially from 4 to 6, carbon atoms between the hydroxyl functional groups.

3. The thermoplastic polyurethane elastomer as claimed in claim 1, exhibiting a number-average molecular weight (Mₙ) of between 10 000 and 100 000 g/mol, preferably between 20 000 and 80 000 g/mol, more preferentially between 30 000 and 60 000 g/mol.

4. The thermoplastic polyurethane elastomer as claimed in claim 1, exhibiting two glass transition temperatures, a first Tg between −70° C. and 0° C., preferably between −65° C. and −10° C., more preferentially between −60° C. and −20° C., and a second Tg between 20° C. and 125° C., preferably between 30° C. and 115° C., more preferentially between 35° C. and 105° C.

5. The thermoplastic polyurethane elastomer as claimed in claim 1, exhibiting a melting point between 110° C. and 220° C., preferably between 130° C. and 200° C., more preferentially between 140° C. and 180° C.

6. The thermoplastic polyurethane elastomer as claimed in claim 1, exhibiting an enthalpy of fusion between 4 and 10 J/g.

7. A composition comprising a binder and the thermoplastic polyurethane elastomer as claimed in claim 1, characterized in that the composition comprises from 3% to 30%, preferably from 5% to 22%, by weight of thermoplastic polyurethane elastomer, with respect to the total weight of the binder and of the thermoplastic polyurethane elastomer.

8. The composition as claimed in claim 7, comprising from 5% to 13%, in particular from 7% to 12%, more particularly from 9% to 11%, by weight of thermoplastic polyurethane elastomer, with respect to the total weight of the binder and of the thermoplastic polyurethane elastomer.

9. The composition as claimed in claim 7, comprising from 17% to 22%, in particular from 18% to 21%, more particularly from 19% to 20%, by weight of thermoplastic polyurethane elastomer, with respect to the total weight of the binder and of the thermoplastic polyurethane elastomer.

10. The composition as claimed in claim 7, characterized in that the binder is chosen from an asphalt, a biobased binder and a mixture of these.

11. A waterproofing membrane, a soundproofing membrane, a liquid waterproofing system, a roadway pavement, a primer, a varnish, a mastic, an adhesive or a binder emulsion, comprising the composition according to claim 7.
